(19) United States
(12) Patent Application Publication
(10) Pub. No.: US 2010/0278661 A1
(43) Pub. Date: Nov. 4, 2010

(54) VALVE COVER ASSEMBLY

(75) Inventor: Don Clemens, Spring, TX (US)

Correspondence Address: PATTERSON & SHERIDAN, L.L.P., 3040 POST OAK BOULEVARD, SUITE 1500, HOUSTON, TX, 77056, US

(73) Assignee: TSC OFFSHORE GROUP LIMITED, Houston, TX (US)

(21) Appl. No.: 12/770,442

(22) Filed: Apr. 29, 2010

Related U.S. Application Data
(60) Provisional application No. 61/174,310, filed on Apr. 30, 2009.

(51) Int. Cl. F04B 17/00; F16J 15/16; F16K 51/00

(52) U.S. Cl. 417/321; 277/300; 137/343

(57) ABSTRACT

A method and apparatus for sealing an opening of a fluid manifold is provided. A grooved sealing member, having compliant members disposed in the grooves, is seated in the opening. A retention member is coupled to the fluid manifold by tensile members such as bolts. One or more compression members fit between the retention member and the sealing member, and a cap fits over the sealing member to secure the one or more compression members. The cap is fastened to the sealing member. When pressure is applied inside the fluid manifold, the force generated thereby is transmitted by the sealing member through the one or more compression members, and the retention member, to the tensile members, which absorb and equalize the force around the sealing member.

### CROSS-REFERENCE TO RELATED APPLICATIONS

This application claims benefit of U.S. Provisional Application Ser. No. 61/174,310, filed Apr. 30, 2009, which is incorporated herein by reference.

### FIELD

Embodiments of the invention relate to accessories for reciprocating force delivery devices. More specifically, embodiments disclosed herein relate to sealing methods and devices for a pressurized fluid manifold.

### BACKGROUND

Production of oil and gas is a trillion dollar industry. To get oil and gas out of the earth, large costly equipment is used under extreme conditions. Among this equipment are reciprocating pumps that generate very high pressures for pumping liquids into and out of holes that are miles deep into the earth. Such pumps are either pumping against the pressure of fluids trapped beneath millions of tons of rock or taking suction of those fluids, so they must be functional for long periods of time under extreme stress.

One example of a reciprocating pump that routinely develops pressures of several thousand pounds per square inch is a drilling fluid pump. Drilling fluid (also called “drilling mud”) is a dense, viscous substance pumped into an active drilling hole to cool the drilling bit, lubricate the drill stem, support the walls of the wellbore, discourage premature entry of fluids into the wellbore, reveal the presence of oil or gas in a drilling formation, and carry cuttings to the surface where they can be removed. Higher viscosity drilling fluid is able to carry more and heavier cuttings, so additives are frequently used to increase viscosity. Drilling fluid pumps routinely develop pressures of several thousand pounds per square inch.

Reciprocating force delivery devices such as drilling fluid pumps operate by guiding a piston in a cylinder. One end of the cylinder will be coupled to a fluid manifold which admits fluid when the piston is retracted. When the piston is advanced the fluid is forced from the fluid manifold under pressure. In many cases, the fluid manifold has one or more openings that allow access to the interior thereof as needed. For the fluid manifold to operate properly, these openings must be reliably sealed against the extreme pressures applied to the fluids therein. Traditionally, blinds or covers are bolted on to cover the opening. The covers may be heavy to lift and handle, and the bolts are sometimes tightened by hitting a long wrench with a sledgehammer.

Equipment such as a drilling fluid pump is routinely used at locations which may be far from any available supplies. Availability of non-standard tools may be severely limited in the event of a failure of any kind, so ease of use and standardization is favored in all such equipment. Thus, there is a continuing need for manifold opening covers that can withstand the extreme pressures generated by reciprocating force delivery devices, while being easy to use and requiring no non-standard tools.

### SUMMARY

Embodiments disclosed herein provide a cover assembly for a valve body, comprising a plug for mating with an opening in the valve body, a retention ring having an inner diameter larger than a largest outer diameter of the plug, a plurality of inserts disposed between the plug and the retention ring, and a cap disposed within the retention ring and fastened to the plug.

Other embodiments provide a cover assembly for a fluid manifold, comprising a sealing member, a retention member over the sealing member, one or more compression members between the sealing member and the retention member, a cap over the sealing member and the one or more compression members, and one or more tensile members configured to urge the retention member against the fluid manifold and the compression members.

Other embodiments provide a method of sealing an opening in a valve body, comprising disposing a sealing member in the opening, wherein a surface of the sealing member is sealably engaged with a surface of the opening, and transmitting an outward force on the sealing member to a retention member having tensile elements that oppose the outward force.

Other embodiments provide a force delivery device, comprising a motor, a reciprocating drive, a piston assembly, and a fluid manifold having at least one service opening sealed by a cover assembly comprising a sealing member disposed in the service opening, a retention member over the sealing member, one or more inserts between the sealing member and the retention member, a cap over the sealing member and the one or more inserts, and one or more fasteners holding the retention member against the fluid manifold.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an exploded isometric view of a fluid manifold according to one embodiment.

FIG. 2 is a cross-sectional view of the fluid manifold of FIG. 1.

FIG. 3 is a detail view of the fluid manifold of FIG. 1.

FIG. 4 is a schematic side view of a force delivery device according to another embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the invention provide methods and apparatus for sealing a fluid manifold for a reciprocating force delivery device such as a drilling fluid pump. In one embodiment, a cover assembly for a fluid manifold is provided. The fluid manifold may be a valve body in some embodiments. The fluid manifold may be part of a force delivery device, such as a reciprocating pump or compressor, in some embodiments. The fluid manifold generally has one or more openings provided to facilitate access to an interior portion of the fluid manifold for maintenance or cleaning. When the fluid manifold is in service, the cover assembly seals the openings against the extreme pressure developed inside the fluid manifold by the force delivery device. Fluid manifolds that may benefit from embodiments disclosed herein include manifolds for liquid, vapor, or mixed phase service, and may include drilling fluid pumps, crude oil pumps, and reciprocating compressors.

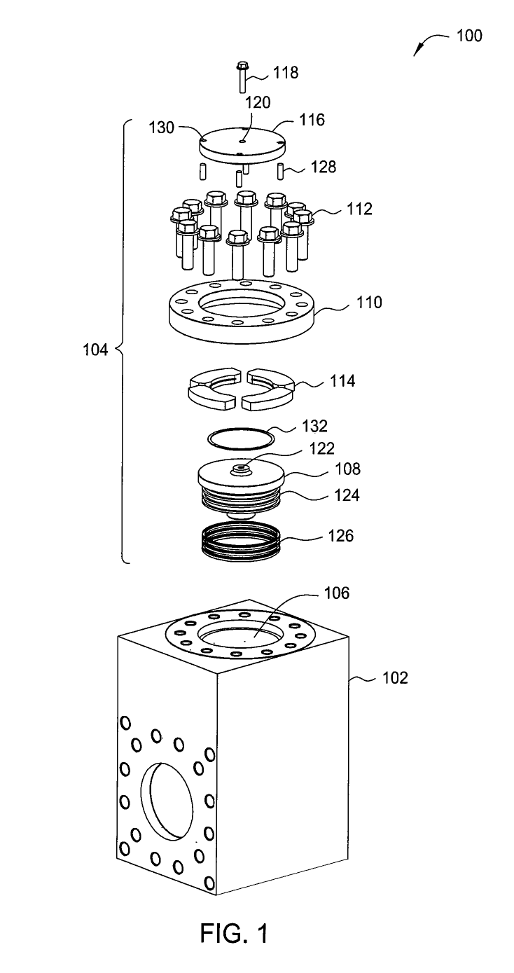

FIG. 1 is an exploded isometric view of a fluid manifold 100 according to one embodiment. The fluid manifold 100 comprises a body 102 and a cover assembly 104 coupled to the body 102. The cover assembly 104 covers an opening 106 in the body 102. The cover assembly 104 comprises a sealing member 108, which is sealably disposed within the opening 106 when the apparatus is assembled, and a retention member 110 disposed adjacent the sealing member 108. The retention member 110, which may be a retention ring in some embodiments, is coupled to the body 102 by a plurality of fasteners 112, such as bolts. One or more inserts 114 is disposed between the retention member 110 and the sealing member 108. In embodiments featuring more than one insert, a positioner 132 is disposed around an inner extent of the inserts 114 to maintain their spacing within the assembly. A cap 116 adjacent to the one or more inserts 114 fits within an inner boundary of the retention member 110, and is coupled to the sealing member 108 by a fastener 118, such as a bolt, which extends through an opening 120 in the cap 116 to mate with an opening 122 in the sealing member 108. The sealing member 108 comprises a plurality of recesses 124, within each of which is disposed a compliant member 126, such as a seal or o-ring seal. The compliant members 126 are urged against the inner surface of the opening 106 in the body 102 when the sealing member 108 is in place, forming a seal against the pressure within the fluid manifold 100. In embodiments featuring a plurality of inserts 114, the cap 116 has a plurality of spacers 128 fitted into, and projecting from, openings 130 to regulate spacing of the inserts 114 when the fluid manifold 100 is assembled.

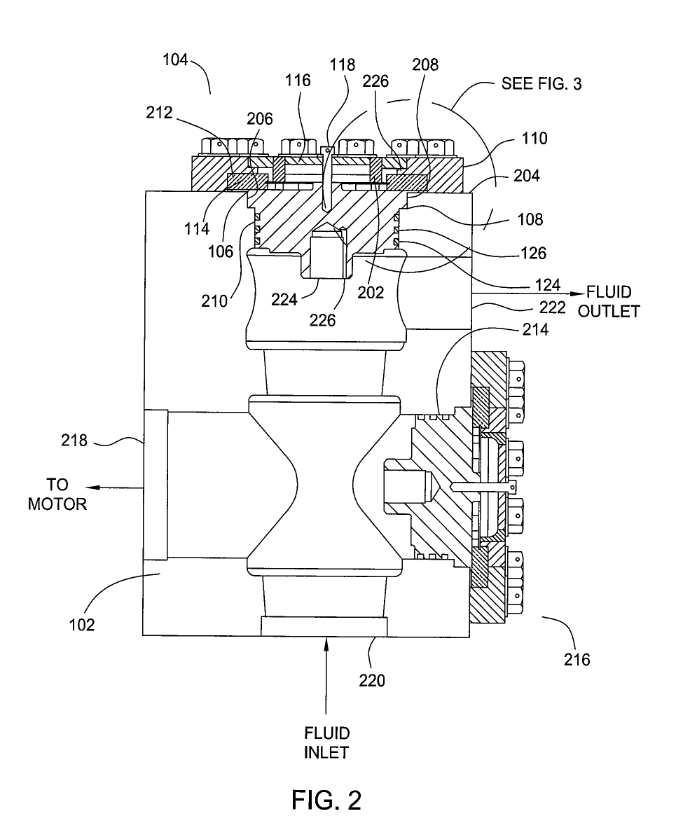

FIG. 2 is a cross-sectional view of the fluid manifold of FIG. 1 in an assembled state. The sealing member 108 is inserted into the opening 106 such that a surface 202, such as the top surface, of the sealing member 108 is substantially coplanar with a surface 204 of the body 102. The sealing member 108, which in some embodiments may be a plug, has a lip 206 that fits within a corresponding recess 208 in the opening 106. The compliant members 126 disposed within the recesses 124 of the sealing member 108, which may be grooves in some embodiments, impinge on the inner surface 210 of the opening 106 to form a seal. The recess 208 is generally no closer to the closest recess 124 than a width of the closest recess 124 in order to maintain the seal of the compliant members 126 against the inner surface 210 of the opening 106 as pressure in the fluid manifold moves the sealing member 108 upward against the inserts 114. The compliant members 126 and recesses 124 may generally be located at any point along the sealing surface of the sealing member 108 where it contacts the inner surface 210 of the opening 106 if appropriate spacing of recesses 124 from discontinuities of the inner surface 210 is maintained.

The inserts 114 occupy a recess 212 cooperatively formed by the retention member 110, the cap 116, the surface 204 of the body 102, and the sealing member 108. The inserts 114 extend over the sealing member 108 to provide containment for the sealing member 108. Fastening of the cap 116 to the sealing member 108 by fastener 118 restrains the inserts 114 from rotating under the moment produced by the sealing member 108 and the retention member 110. In alternate embodiments, the recess 212 may be defined by any object having a fitting resembling the retention member 110. For example, another functional module, such as a valve body or a pump inlet or outlet, may be provided with a recess and fitting similar to the retention member 110

The retention member 110 comprises a ledge 228 that extends between the inserts 114 and the cap 116, such that the cap 116 contacts the ledge 228 when the cap is positioned over the sealing member 108. The ledge 228 supports the cap 116 as the fastener 118 is tightened, ensuring the sealing member 108 does not move with pressure cycles. In the embodiment of FIG. 2, the ledge 228 creates a gap 230 between the cap 116 and the inserts 114. In other embodiments, the ledge 228 may be replaced by increasing the width of the cap 116 to contact the surface of the inserts 114, rather than the ledge 228.

In some embodiments, the body 102 features a second opening 214 for accessing the interior of the body 102 from a second direction, as shown in FIG. 2. A second cover assembly 216, is shown sealing the second opening 214. The second cover assembly 216 may be identical to the first cover assembly 104 to the extent the second opening 216 is identical to the first opening 106.

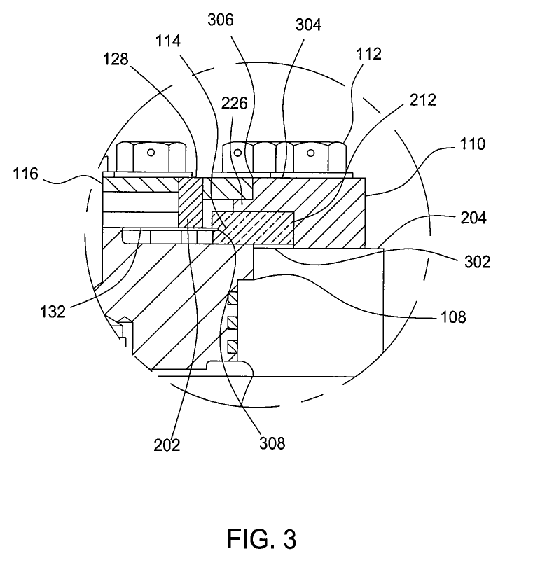

FIG. 3 is a detail view of the body 102 and the cover assembly 104 of FIG. 2. As can be seen in FIG. 3, the inserts 114 have a thickness that is less than the thickness of the recess 212 formed by the retention member 110 and the surface 204. When the cover assembly 104 is installed and the body 102 pressured, a gap 302 forms between the inserts 114 and the surface 204, as described further below. The cap 116 and the sealing member 108 constrain the inserts 114 from movement or rotation under load, allowing only movement upward to contact the retention member 110 as pressure builds in the body 102. The retention member 110 has an extension 304 that extends over the one or more inserts 114, forming an abutment 306 with the cap 116. The one or more inserts 114 contacts the abutment 306 when the body 102 is pressurized, and force from the pressure in the body 102 is transmitted by the sealing member 108 through the one or more inserts 114 to the retention member 110 to the one or more fasteners 112, which may be bolts in some embodiments. The one or more inserts 114 also undergo a shear force at the point of contact with the abutment 306 by misalignment of the force from the sealing member 108 and the combined forces from the cap 116 and the retention member 110. This misalignment of forces also generates a moment on the one or more inserts 114, which is partially counteracted by a lateral force from the retention member 110 on the one or more inserts 114.

In embodiments featuring more than one insert 114 with a ring-like positioner 132, the inserts 114 may each have a groove 308 for accommodating the positioner 132. In general, the positioner 132 may be a compliant member, such as a ring, disk, cylinder, or other body shaped to contact the inserts 114 at an inner extent of each insert 114. A ring-like positioner 132 may be installed in the grooves 308 of the inserts 114 to hold the inserts 114 in position during application of the cover assembly 104. The positioner 132 facilitates adjusting the spacing of the inserts 114 before the cap 116 with spacers 128 is installed.

In operation, the cover assembly 104 is installed by seating the sealing member 108 and attaching the retention member 110 by installing the fasteners 112. The extension 304 of the retention member forms the recess 212 in cooperation with the surface 204 of the body 102. After attaching the retention member 110, the one or more inserts 114 are seated into the recess 212 between the retention member 110 and the surface 204 of the body 102. The cap 116 is then disposed within an inner diameter of the retention member 110 and fastened to the sealing member 108. In embodiments having a plurality of inserts 114, such as that shown in FIG. 3, the spacers 128, which may be pins in some embodiments, projecting from the cap 116 maintain spacing among the inserts 114 when the cap 116 is fastened in place.

When pressure inside the fluid manifold is applied to the sealing member 108, force is transmitted through the inserts 114 to the retention member 110. Because pressure is applied isotropically, the fasteners 112 are loaded with tensile stress to equalize compression of the inserts 114. The fasteners 112 thus serve as tensile members, equalizing the sealing force between the retention member 110 and the surface 204 of the body 102, and at the seal points of the sealing member 108, regardless of the tension applied to the fasteners 112 at installation. As the fasteners 112 load, they may strain to some extent, allowing a gap to open between the inserts 114 and the surface 204. Because the sealing member 108 seals along an extended portion of the surface 210 of the opening 106, the seal is maintained despite the slight elongation of the fasteners 112.

Referring to FIG. 2, the force delivery device (not shown) is generally coupled to a force input opening 218. Fluid enters the body 102 through an inlet 220. When the piston (not shown) retracts from the force input opening 218, a vacuum opens an inlet valve (not shown) blocking the inlet 220 inside the body 102. When the piston advances toward the force input opening 218, pressure builds inside the body 102. The inlet valve blocks the inlet 220, and an outlet valve (not shown) inside the body 102 unseats to open a discharge 222. Fluid under pressure inside the body 102 exits through the discharge 222. The sealing member 108 has an opening 224 that guides movement of the outlet valve, which seats against the opening 224 of the sealing member 108 when the outlet valve is open. A notch 226 in a peripheral portion of the opening 224 allows pressure behind the open discharge valve to equalize.

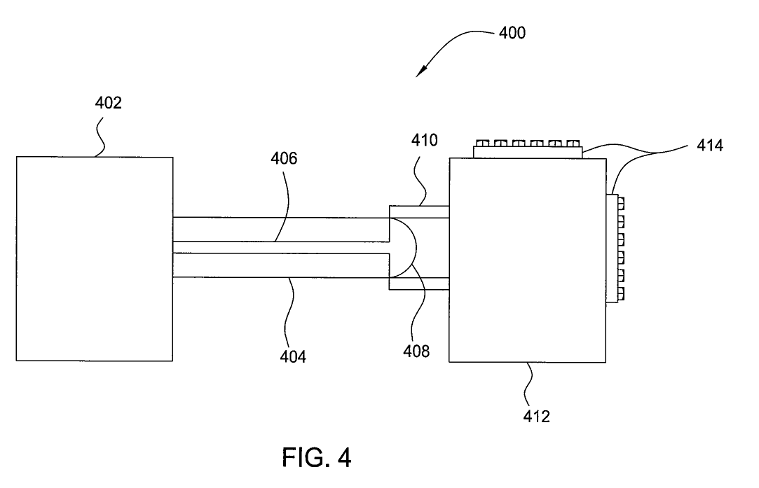

FIG. 4 is a schematic side view of a force delivery device 400 according to another embodiment. The force delivery device 400 comprises a motor 402 or other motive element, a piston assembly 404, comprising a piston rod 406 and piston 408, coupled to a cylinder 410. The cylinder 410 is coupled to a fluid manifold 412 having one or more service openings, each service opening having a cover assembly such as that described in connection with FIGS. 1-3 coupled thereto.

I alternate embodiments, the sealing member 108 and the inner surface 208 of the opening 106 may be threaded to seal the opening 106. A sealing material may be applied to the threads prior to screwing the sealing member 108 into the opening 106.

Embodiments disclosed herein provide a method of sealing an opening in a fluid manifold, comprising disposing a sealing member in the opening, and transmitting an outward force on the sealing member to a retention member having tensile elements that oppose the outward force. The force is spread and equalized by providing one or more compression members between the sealing member and the retention member to absorb a portion of the force by deforming slightly under load. Pressure from the fluid manifold applies force to the tensile elements in the amount required to equalize downward compensating force on the sealing member. The tensile elements may have different loads in the absence of manifold pressure, but pressuring the manifold causes each tensile member to absorb exactly the load necessary to equalize force on all sides of the sealing member. The number of tensile members required generally depends on the tensile strength of each member and the total force (pressure×area) to be applied to the sealing member.

The tensile elements are disposed outside an outer diameter of the sealing member to provide an independent restraining force. The retention member is therefore generally shaped to extend partly over the sealing member and partly beyond the sealing member. As such, the combined compressive force of the sealing member and the retention member may form a rotational moment on the compression members. This moment may be counteracted by providing a restraint over the portion of the compression members that extends beyond the retention member to counteract the moment. A restraining member may be provided to apply the force to counteract the moment, keeping the compression members in place. If multiple compression members are used, spacers may be provided to maintain position of the compression members as load is applied. Maintaining spacing of the compression members equalizes distribution of the force on the compression members, and generally maintains the symmetry of the assembly so no seal is broken. The spacers may also serve to maintain position of the compression members in different rotational configurations.

In alternate embodiments, the retention member may be eliminated, and the tensile members applied through openings in the compression members. A single compression member may also be used instead of a plurality of compression members. A single compression member comprising a plate that fits over the sealing member and under the cap may be used instead of the annular shaped compression members. A single compression member having a cross shape may also serve in some embodiments. In other alternate embodiments, the cap may be eliminated. In such an embodiment, moment on the compression members is generally counteracted by extending the retention member over the entire width of the compression members, or by providing a unitary compression member.

While the foregoing is directed to embodiments of the invention, other and further embodiments of the invention may be devised without departing from the basic scope thereof.

While the foregoing is directed to embodiments of the invention, other and further embodiments of the invention may be devised without departing from the basic scope thereof.

What is claimed is:

1. A cover assembly for a valve body, comprising:
a grooved plug shaped for mating with an opening in the valve body;
a retention ring having an inner diameter larger than a largest outer diameter of the grooved plug;
a plurality of inserts disposed between the grooved plug and the retention ring; and
a cap disposed within the retention ring and fastened to the grooved plug.

2. The cover assembly of claim 1, wherein the inserts are compression members.

3. The cover assembly of claim 1, wherein the inserts are disposed between grooved plug and the cap.

4. The cover assembly of claim 3, further comprising pins between the inserts that project into openings within the cap.

5. The cover assembly of claim 1, further comprising bolts extending through the retention ring into openings in the valve body.

6. The cover assembly of claim 5, wherein the bolts are disposed outside an outer extent of the inserts.

7. The cover assembly of claim 1, wherein the cap has an outer diameter smaller than an inner diameter of the retention ring.

8. The cover assembly of claim 1, wherein an upper surface of the grooved plug extends above an upper surface of the valve body.

9. The cover assembly of claim 1, wherein the inserts contact an abutment between the cap and the retention ring.

10. The cover assembly of claim 9, wherein the inserts, the retention ring, the grooved plug, and the valve body cooperatively define a gap.

11. A cover assembly for a fluid manifold, comprising:
a sealing member;
a retention member over the sealing member;
one or more compression members between the sealing member and the retention member;
a cap over the sealing member and the one or more compression members; and
one or more tensile members configured to urge the retention member against the fluid manifold and the compression members.

12. The cover assembly of claim 11, wherein the retention member and the cap each has a recess, which cooperatively form a space into which the one or more compression members fit.

13. The cover assembly of claim 12, wherein the sealing member comprises one or more grooves, each with a compliant member disposed therein.

14. The cover assembly of claim 13, wherein the one or more compression members extend over an abutment between the sealing member and the valve body.

15. The cover assembly of claim 14, wherein the one or more compression members contact an abutment between the retention member and the cap.

16. The cover assembly of claim 11, wherein the compression members transmit an outward force to the retention member.

17. The cover assembly of claim 11, wherein the retention member has an inner extent that is larger than an outer extent of the sealing member and of the cap, and a plurality of spacers extend from openings in the cap to positions between the compression members.

18. A method of sealing an opening in a valve body, comprising;
disposing a sealing member in the opening, wherein a surface of the sealing member is sealably engaged with a surface of the opening; and
transmitting an outward force on the sealing member to a retention member having tensile elements that apply an opposing force on the sealing member.

19. The method of claim 18, further comprising equalizing the opposing force on the sealing member by providing one or more compression members between the sealing member and the retention member.

20. The method of claim 19, further comprising simultaneously counteracting rotational force on the one or more compression members.

21. A force delivery device, comprising:
a motor;
a reciprocating drive;
a piston assembly; and
a fluid manifold having at least one service opening sealed by a cover assembly, comprising:
a sealing member disposed in the service opening;
a retention member over the sealing member;
one or more inserts between the sealing member and the retention member;
a cap over the sealing member and the one or more inserts; and
one or more fasteners holding the retention member against the fluid manifold.
